(19) United States
(12) Patent Application Publication
(10) Pub. No.: US 2008/0024832 A1
(43) Pub. Date: Jan. 31, 2008

(54) Method for amending scanned images

(75) Inventors: Po-Chon Kao, Taoyuan Hsien (TW); Sheng-Min Wang, Keelung City (TW)

Correspondence Address: BIRCH STEWART KOLASCH & BIRCH, PO BOX 747, FALLS CHURCH, VA, 22040-0747, US

(73) Assignee: BENQ Corporation

(21) Appl. No.: 11/878,756

(22) Filed: Jul. 26, 2007

(30) Foreign Application Priority Data
Jul. 28, 2006 (TW) 95127891

(51) Int. Cl. H04N 1/387

(52) U.S. Cl. 358/452

(57) ABSTRACT

A method for amending scanned images is applicable to a scanner having a plurality of contact image sensors. The method comprises a step of receiving a digital image data; a step of determining if the digital image data includes an abnormal pixel; a step of retrieving two adjacent pixels of the abnormal pixel if positive; a step of obtaining a mean pixel by averaging the two adjacent pixels; and a step of amending the digital image data by replacing the abnormal pixel with the mean pixel so as to obtain an amended digital image data.

This application claims the benefit of Taiwan Patent Application Serial No. 95127891, filed Jul. 28, 2006, the subject matter of which is incorporated herein by reference.

### BACKGROUND OF THE INVENTION

(1) Field of the Invention

The invention relates to a method for amending scanned images, and more particularly to an adjusting method that can eliminate the abnormal line existing in the spacing between two adjacent contact image sensors.

(2) Description of the Prior Art

In the art, the scanner can be simply classified into one that uses the charge couples devices (CCD) or one that uses the contact image sensors (CIS). Generally speaking, both types of the scanners can provide satisfied images, but the depth of field in a CCD-type scanner is better than that in a CIS-type scanner.

Recently, for the trend in slimness of the scanner and the presence of the multi-function printer that integrates the scanner, the copier and the conventional printer, the CIS consisted of CCD chips has been widely adopted. For a CIS having M pixels and N CCD chips, then each of the CCD chips would be responsible to M/N pixels.

Due to the limitations of the CCD chip in physical properties and manufacturing process, every first pixel of the CCD chips (i.e. the pixel at the conjunction of the adjacent CCDs) would be abnormal in imaging. Generally, the abnormality is an unexpected line in the image. Referring to FIG. 3, a scanned wave form including an abnormal pixel is shown. In FIG. 3, the wave form 302 indicates signals of a normal pixel, while the wave form 304 represents an abnormal pixel that has overshooting at the wave front. In practice, the scanner having N CCD chips would present N-1 abnormal pixels (304 as shown in FIG. 3). Apparently, these abnormal pixels would damage the image quality of the scanner.

### SUMMARY OF THE INVENTION

Accordingly, it is an object of the present invention to provide a method for amending scanned images, which can eliminate the abnormal line existing in the spacing between two adjacent contact image sensors.

In the present invention, the method for amending scanned images is firstly to receive digital image data. Then, the digital image data are judged whether or not an abnormal pixel is included. In the case that an abnormal pixel is included, data of the two neighbor pixels are introduced to calculate mean values for defining a mean pixel. Finally, the mean pixel is used to replace the abnormal pixel.

In one embodiment of the present invention, the method for amending scanned images further includes a step of outputting the digital image data including the mean pixel to a computer or a printer.

In one embodiment of the present invention, the step of judging the abnormal pixel further includes the steps of: determining a first coordinate respective to the digital image data, judging if the first coordinate falls in the spacing between two adjacent contact image sensors, defining the digital image data as the abnormal pixel if positive, and defining the digital image data as those excluding the abnormal pixel if negative.

In one embodiment of the present invention, the step of judging the abnormal pixel further includes the steps of: determining a second coordinate respective to the digital image data, judging if the second coordinate falls in the spacing between two adjacent contact image sensors, defining the digital image data as the abnormal pixel if positive, and defining the digital image data as those excluding the abnormal pixel if negative.

All these objects are achieved by the method for amending scanned images described below.

### BRIEF DESCRIPTION OF THE DRAWINGS

The present invention will now be specified with reference to its preferred embodiment illustrated in the drawings, in which:

FIG. 1 is a schematic view of part of interiors of a preferred scanner in accordance with the present invention;

FIG. 2A is a flowchart of a preferred method for amending scanned images in accordance with the present invention;

FIG. 2B is a schematic view of coordinates of the digital image data and the contact image sensors in accordance with the present invention; and

FIG. 3 is a wave form plot showing scanned image data including an abnormal pixel.

### DESCRIPTION OF THE PREFERRED EMBODIMENT

The invention disclosed herein is directed to a method for amending scanned images. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

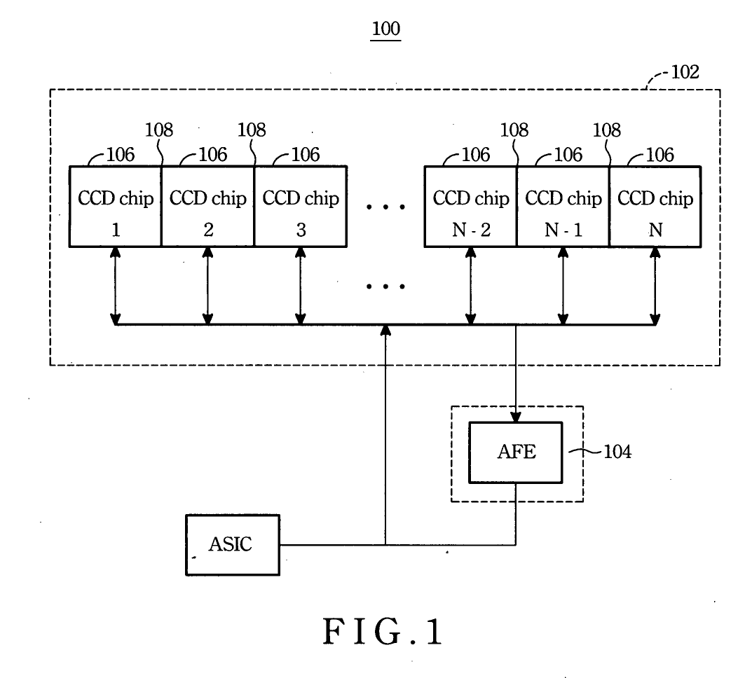

Referring now to FIG. 1, part of the interiors of a preferred scanner in accordance with the present invention is shown. In this figure, only parts of the scanner 100 involved in the method for amending scanned images of the present invention are illustrated. As shown, the scanner 100 comprises at least a contact image sensor (CIS) 102, a functional chip 104, N charge coupled device (CCD) chips 106 and spacings 108 between every two adjacent CCD chips 106.

In this embodiment, the number N is only a plural number for the explanation purpose, not to restrict the embodying of the present invention. As noted, the N CCD chips would generate (N-1) spacings 108.

In the present invention, an analog front-end (AFE) of the functional chip 104 is used to receive control signals from an application specific integrated circuit (ASIC) of the scanner 100 and further to process the control signals and then output the signals to the N CCD chips 106. The control signal can be a reset signal, a clock signal, a trigger signal, or any the like.

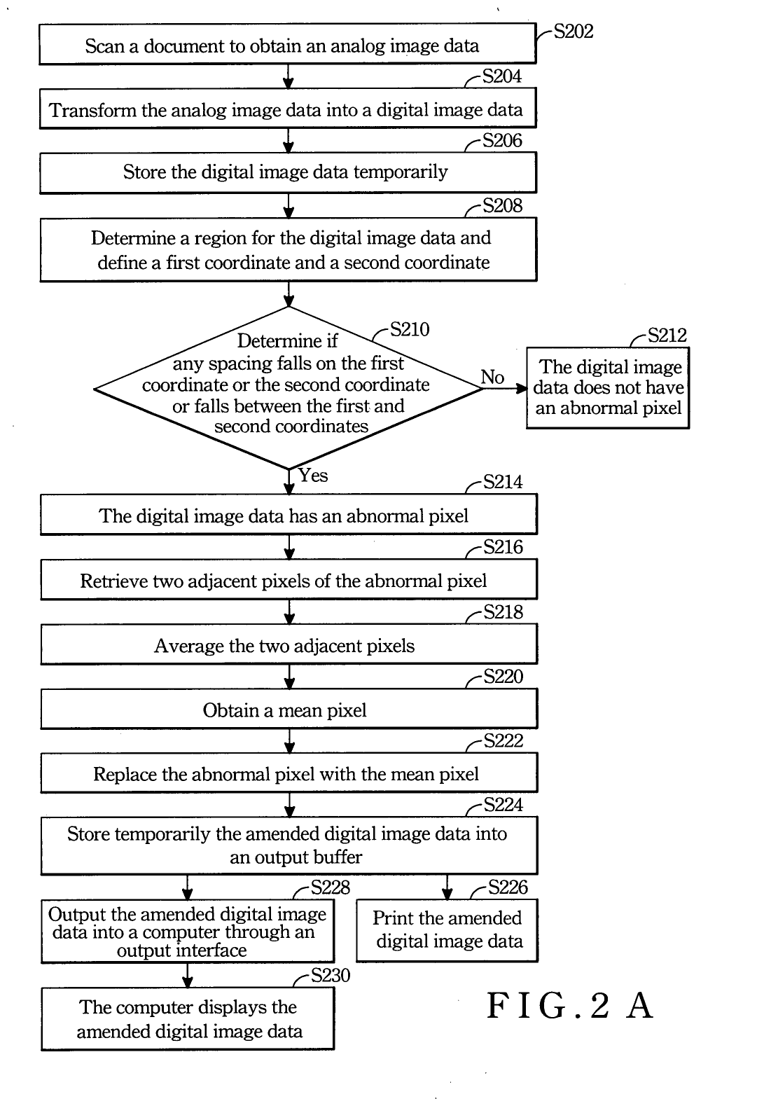

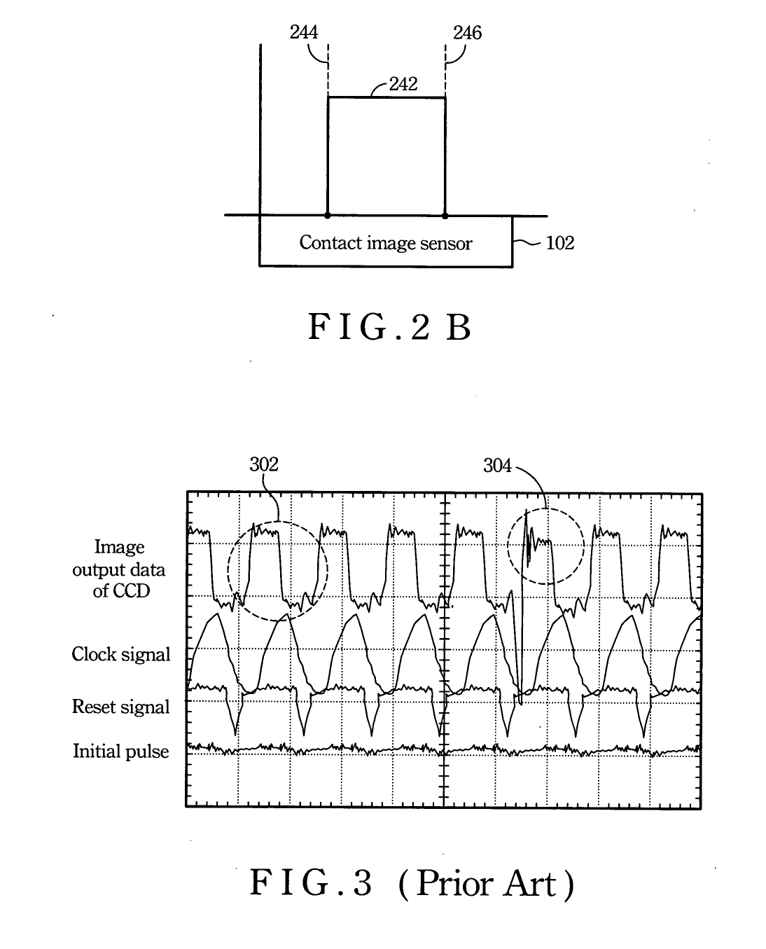

Referring now to FIG. 2A, a flowchart of a preferred method for amending scanned images is shown. Firstly in step S202, the scanner 100 uses a CIS 102 to scan a document, from which the CCD chips 106 of the CIS 102 would receive photo signals of the document and then transform the photo signals into respective analog image data. The analog image data is then forwarded to an analog-to-digital (A/D) converter.

Then, in step S204, the A/D converter transforms the analog image data into respective digital image data. In step S206, the digital image data is then stored temporarily to a buffer of the scanner 100 through the application specific integrated circuit (ASIC) of the scanner 100.

Refer further to FIG. 2B, where a schematic view of coordinates of the digital image data and the contact image sensors in accordance with the present invention is shown. In step S208, the scanner 100 would determine a region for the digital image data 242 so as to define a first coordinate 244 (the left-hand-side boundary) and a second coordinate 246 (the right-hand-side boundary) along the same axis. The first coordinate 244 and the second coordinate 246 define a stroke for the CIS 102 to scan along the axis.

In the present invention, while in assembling the scanner 100, every CCD chip 106 of the CIS 102 has been assigned an initial coordinate and an end coordinate. The spacing 108 between every two adjacent CCD chips 106 is then defined between the end coordinate of the concerned CCD chip 106 and the initial coordinate of the following CCD chip 106. That is, the end coordinate of the concerned CCD chip 106 defines an initial coordinate of the spacing 108, and the initial coordinate of the following chip 106 defines an end coordinate of the spacing 108.

In step S210, determine whether or not the region of the digital image data 242 overlaps any spacing 108. That is to determine if any initial or end coordinate of any spacing 108 falls within the region of the digital image data 242 defined by the first coordinate 244 and the second coordinate 246. Alternatively, determine if either the first coordinate 244 or the second coordinate 246 of the digital image data 242 falls between the initial coordinate and the end coordinate of a specific spacing 108 of the scanner 100.

In the case (S212) that none of the first coordinate 244, the second coordinate 246, and any coordinate between the first coordinate 244 and the second coordinate 246 falls between the initial coordinate and the end coordinate of any spacing 108 of the scanner 100, it implies that no abnormal pixel caused by the spacing 108 can exist in this digital image data 242.

In the case (S214) that any spacing falls on the first coordinate 244 or the second coordinate 246 or falls between the first coordinate 244 and the second coordinate 246, it implies that an abnormal pixel caused by the spacing 108 is met in this digital image data 242.

In step S216 after step S214, the scanner 100 retrieves two adjacent pixels (i.e. the preceding and the following) of the abnormal pixel, and, in step S220 and step S222, calculates by averaging to obtain a mean pixel to replace the abnormal pixel. By providing the substitute mean pixel, the abnormal pixel as well as its influence to the image can be erased.

Then, in step S224, the scanner 100 stores temporarily the amended digital image data having the substitute mean pixel into an output buffer of the scanner and waits for further instructions from a user. As soon as a print instruction is received, the scanner 100 outputs the amended digital image data to a printer for printing (S226).

On the other hand, in step S228, in the case that an instruction of storing the data into a computer is received, the scanner stores the amended digital image data into the computer through an output interface. The computer, then, can display the amended digital image data (S230).

Preferably, the output interface of the present invention can be a universal serial bus (USB), or any interface available in the marketplace.

In the present invention, the scanner 100 can be a pure scanning apparatus or a multi-function printer.

By providing the present invention described above, it is apparent that the abnormal pixels caused by the spacings in the CIS can be successfully eliminated.

While the present invention has been particularly shown and described with reference to a preferred embodiment, it will be understood by those skilled in the art that various changes in form and detail may be without departing from the spirit and scope of the present invention.

I claim:

1. A method for amending scanned images, comprising:
(a) receiving a digital image data;
(b) determining location of an abnormal pixel in the digital image data;
(c) retrieving two adjacent normal pixels of the abnormal pixel;
(d) obtaining a mean pixel by averaging the two adjacent normal pixels; and
(e) amending the digital image data by replacing the abnormal pixel with the mean pixel so as to obtain an amended digital image data.

2. The method for amending scanned images according to claim 1, further including a step of outputting said amended digital image data after said step (e).

3. The method for amending scanned images according to claim 2, wherein said amended digital image data is outputted to a computer.

4. The method for amending scanned images according to claim 2, wherein said amended digital image data is outputted to a printer.

5. A method for amending scanned images, comprising:
(a) using the contact image sensors to scan a document and thus to obtain an analog image data;
(b) transforming the analog image data into a digital image data;
(c) determining location of an abnormal pixel in the digital image data;
(d) retrieving two adjacent normal pixels of the abnormal pixel;
(e) obtaining a mean pixel by averaging the two adjacent normal pixels; and
(f) amending the digital image data by replacing the abnormal pixel with the mean pixel so as to obtain an amended digital image data.

6. The method for amending scanned images according to claim 7, further including a step of outputting said amended digital image data after said step (f).

7. The method for amending scanned images according to claim 8, wherein said amended digital image data is outputted to a computer.

8. The method for amending scanned images according to claim 8, wherein said amended digital image data is outputted to a printer.
